(19) United States
(12) Patent Application Publication
(10) Pub. No.: US 2008/0150821 A1
(43) Pub. Date: Jun. 26, 2008

(54) FLEXIBLE SUBSTRATE INTEGRATED WAVEGUIDES

(75) Inventors: Stefan KOCH, Oppenweiler (DE); Maysoun Al-Tikriti, Esslingen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Deutschland GmbH, Berlin (DE)

(21) Appl. No.: 11/948,428

(22) Filed: Nov. 30, 2007

(30) Foreign Application Priority Data
Dec. 22, 2006 (EP) 06 127 131.8

(51) Int. Cl. H01Q 13/00

(52) U.S. Cl. 343/776

(57) ABSTRACT

This invention relates to a device operable to guide electromagnetic waves in substrate integrated structures, said substrate integrated structures being made in one component. In detail planar antennas are part of said substrate integrated structures, which are connected to electromagnetic waveguides. This invention also allows 3D structures of the above mentioned components in a multilayer substrate.

### FIELD OF INVENTION

This invention relates to the field of substrate integrated structures, in particular to substrate integrated waveguides. Substrate integrated waveguides are needed particularly for high frequency signals.

### PROBLEM

Communication systems nowadays witnessed rapid evolution towards system integration and miniaturization. The antenna and the channel filters are key components in any of these systems and the selection criteria for a communication success include among other things the antenna performance, size, weight, and cost.

Multibeam antenna systems using a beam switching mechanism for the different antenna units need relatively large spaces in order to connect the antenna units to the system components. These feeding lines suffer from high losses and bad matching, especially for long feeding lines in the region of mm-wave frequencies. In addition, there is low isolation in between these lines and therefore, the crosstalk influences the filter characteristics.

However, the system miniaturization is limited on one hand by the antenna size (for systems needing high gain antennas, the antenna aperture dimensions are directly proportional to the antenna gain). On the other hand, by the size of the feeding network. Hence, if the feeding network can be made smaller, then the overall system size and losses will also be minimized.

In order to meet the above system requirements of modern devices, the feeding network can be realized by using microstrip lines. Microstrip lines are simple to be integrated in the system and may require less space, but they radiate and generate unwanted signals (crosstalk). Furthermore, they suffer from high losses, especially for mm-wave frequencies.

Interesting alternative solutions to microstrip feeding lines are the rectangular waveguides (WGs). These components have been widely used in mm-wave systems. They are characterized by their excellent low losses and they do not generate unwanted radiation. Therefore, they can realize channel filters for e.g. radio-link systems, too. However, their difficulty of integration prevents them from being used in low-cost high-volume of integration. Additionally, conventional WGs require complex transitions to integrated planar circuits; typical integration schemes are bulky and need high precision matching process which is difficult to achieve in the mm-wave frequency range.

### STATE OF THE ART

The conventional method toward system miniaturization and integration is to integrate systems using multilayer techniques. Feeding is then made by using simple microstrip or coplanar lines and via lines to connect feeding lines from one layer to the next one. Microstrip lines sometimes suffer from unwanted radiation and high losses especially for example for mm-wave application

### OBJECTIVES

It is an object of the present invention to provide low-loss, and low-cost signal transmission means for microwave and mm-wave components and subsystems. Moreover the fabrication should be easier but should still allow complex structured components.

### SUMMARY OF THE INVENTION

The present invention relates to a substrate integrated structure operable to guide electromagnetic waves, said substrate integrated structure being one integrated unit, comprising a plurality of substrate integrated waveguides operable to guide an electromagnetic wave, respectively, and a plurality of planar antennas operable to receive and/or emit electromagnetic waves, said plurality of planar antennas being coupled to said plurality of substrate integrated waveguides, respectively.

Favorably said substrate integrated waveguides comprise vias and microstrip conductors.

Favorably at least one of said substrate integrated waveguides comprises an electromagnetic wave frequency filter.

Favorably at least one of said substrate integrated waveguides comprises an interconnection, said interconnection being operable to interconnect at least two of said substrate integrated waveguides.

Favorably said interconnection comprises a multiplexer.

Favorably said substrate integrated structures are implemented in a multilayer substrate.

Favorably at least two of said planar antennas are located at different layers, respectively.

Favorably at least two of said substrate integrated waveguides are located at different layers, respectively.

Favorably at least a part of said vias are a part of all substrate integrated waveguides concurrently.

Favorably the connection between at least one of said planar antennas and said respective substrate integrated waveguide comprises a microstrip line.

The present invention also relates to a method for manufacturing said above mentioned device, said device comprising a plurality of layers, said layers comprising components respectively, wherein vias are produced through a layer of said device in the same step as a component of the respective layer and/or the respective layer are/is produced.

In another method for manufacturing said above mentioned device, said device comprises a plurality of layers, said layers comprising components respectively, whereby vias are produced through a layer of said device after all other components of the device are produced.

Favorably the vias extend perpendicular through at least one layer.

### DESCRIPTION OF THE DRAWINGS

The features, objects and advantages of the present invention will become more apparent from the detailed description set forth below when taken in conjunction with the drawings, wherein:

FIG. 1 shows an embodiment of the present invention comprising a substrate structure,

FIG. 2 shows another embodiment of the present invention comprising a substrate structure,

FIG. 3 shows another embodiment of the present invention comprising a substrate structure,

FIG. 4 shows another embodiment of the present invention comprising a substrate structure, and

FIG. 5 shows another embodiment of the present invention comprising a substrate structure.

### DESCRIPTION OF THE INVENTION

FIG. 1 shows a substrate structure (1) comprising its topview (2) and its cross section (3).

The topview (2), said topview allowing the view of the components partially lying beneath the surface, said surface comprising the top layer (11a), shows a first planar antenna (4a), a second planar antenna (4b), a third planar antenna (4c), the respective microstrip lines (6a, 6b, 6c), the respective substrate integrative waveguides (SIWG) (5a, 5b, 5c) and the respective feeding lines (7a, 7b, 7c) which are all part/integrated on or in the substrate (11). All above mentioned components are located on the same substrate/component, thus can be subsequently and/or stepwise fabricated on the same wafer or semiconductor substrate or LCP (liquid crystal polymer) substrate or any other material suitable for superimposing said substrate structure (1).

The planar antennas (4a, 4b, 4c) are located in a row and symmetrical along the symmetry axis X, are equidistant to each other and are shaped quadratically. The planar antennas (4a, 4b, 4c) have the width W and the length L, respectively. Said planar antennas can also be shaped in another form like in a circular or curved way and/or have different distances to each other depending on the demanded profile of the electromagnetic field resulting from and radiated by said antennas. In another example at least two planar antennas are part of the substrate integrated structure and/or are asymmetrically placed in respect to the symmetry axis X and/or horizontally and/or vertically shifted to each other in respect to the topview (2). Of course the planar antennas (4a, 4b, 4c) can also have different sizes, respectively.

The microstrip line (6a, 6b) comprises horizontal and vertical lines in respect to the topview (2) which are perpendicular to each other, more specifically said lines are either perpendicular or parallel to the symmetry axis X. The connection point between a horizontal line and a vertical line or vise-versa forms a corner. The present invention is not restricted to said corner, but could implement curves and rounded corners, respectively, between two perpendicular lines to reduce leakage of electromagnetic waves. The line, which is perpendicular to the axis X and is part of the respective microstrip line (6a, 6b, 6c), runs through the middle of the space between two antennas (4a & 4b or 4b & 4c), more precisely said has equal distance to both antennas. Of course, said line is not restricted to said feature, but could run closer to one of said antennas. It is also possible to form microstrip lines which are gradually folded by angled pieces of straight microstrip lines, said angles being greater than 90 degree. The microstrip lines (6a, 6b, 6c) interconnect said antennas (4a, 4b, 4c) and said substrate integrated waveguides (5a, 5b, 5c), respectively. In this embodiment all microstrip lines (6a, 6b, 6c) have the same width, which could vary for the respective antenna in other embodiments dependent on e.g. the frequency of the transported signal.

The substrate integrated waveguides (5a, 5b, 5c) comprise a feeding channel (8a, 8b, 8c) and a filter channel (9a, 9b, 9c), respectively. The SIWG is a type of dielectric field waveguide (WG) that is synthesized in planar substrate with arrays of metallic vias in order to realize the edge-walls, also called post-walls, of the WG. The filter channel (9a, 9b, 9c) is characterized by periodically placed vias on both sides of the channel, said vias forming recesses to the middle of the channel or narrowing the channel width as shown in FIG. 1. The vias of one side of a layer are mirrored along the center-line of a substrate integrated waveguide (5a, 5b, 5c) to the other side of said layer. A signal originating from one of said antennas (4a, 4b, 4c) first runs through the respective feeding channel (8a, 8b, 8c) and then enters the respective filtering channel (9a, 9b, 9c). Of course, the sequence of components regarding the feeding channel and the filtering channel which the signals passes might be reversed. The first substrate integrated waveguide (5a) is longer than the second substrate integrated waveguide (5b), whereby said second substrate integrated waveguide (5b) is longer than the third substrate integrated waveguide (5c). The second substrate integrated waveguide (5b) is at least longer than the length of the third planar antenna (4c). The first substrate integrated waveguide (5a) is at least long enough to bypass the first and the second planar antenna (4a & 4b). The third substrate integrated waveguide (5c) has a minimum length to at least comprise the filter channel (9c) which can be directly connected to the third microstrip line (6c) and the third feeding microstrip line (7c). While the first substrate integrated waveguide (5a) bypasses the antennas on one side, the second substrate integrated waveguide (5b) bypasses the antennas on the other side parallel to the symmetry axis X. The three substrate integrated waveguides (5a, 5b, 5c) are parallel to each other, to the row of planar antennas (4a, 4b, 4c) and to the C symmetry axis X, respectively. Of course, the SIWG are not bound to be parallel to each other in other embodiments. In FIG. 1 the width of the substrate integrated waveguides (5a, 5b, 5c), said width being measured perpendicular the symmetry axis X, is smaller than the planar antennas (4a, 4b, 4c), but is larger than the width of the microstrip lines (6a to 6c, 7a to 7c), respectively. In this embodiment all SIWG have the same width, meaning the vias have the same distance to their respective vias being placed on the other side of the SIWG. In other embodiments the width of the SIWG may vary dependent on e.g. the frequency of the transported signal. The distribution of the feeding channel (8a, 8b, 8c) and the filtering channel (9a, 9b, 9c) can vary in different examples, but in FIG. 1 the filtering channel (9a, 9b, 9c) has always a constant length for every substrate integrated waveguide (5a, 5b, 5c) and comprises a much smaller area than the feeding channel (8a, 8b) of the first and second substrate integrated waveguide (5a, 5b). In other examples the substrate integrated waveguides (5a, 5b, 5c) comprises either the feeding channel or the filtering channel.

The first, second and third feeding microstrip lines (7a, 7b, 7c) are attached to the first, second and third substrate integrated waveguides (5a, 5b, 5c), respectively, and are operable to provide a connection point or terminal for signals, said signals being either received by the antennas and sent via the substrate integrated waveguides to external components (not shown in the figure) or received by external components and sent via the substrate integrated waveguides to the antennas for transmission. These external components comprising a receiver and/or a transmitter might be located on the same component as the substrate structure (1) or has to be linked via wires to the substrate structure (1) via said terminal. The first, second and third feeding microstrip lines (7a, 7b, 7c) can be formed like the first, second and third microstrip lines (6a, 6b, 6c) as previously mentioned.

The cross section (3) of the substrate integrated structure (1) shows a first, a second and a third layer (11a, 11b, 11c), a groundlayer (15), the first, second and third planar antenna groups (21a, 21b, 21c) comprising a first layer (12a, 12b, 12c), second layer (13a, 13b, 13c) and a third layer (14a, 14b, 14c), respectively, the first, second and third microstrip line (6a, 6b, 6c), the third substrate integrated waveguide (5c) and the third feeding microstrip line (7c). As mentioned in the top view (2) the microstrip lines (6a, 6b) are connected to their respective antenna (4a, 4b), but said connection is not shown in the cross section (3) due to reasons of clarity.

The antenna group (21a) is equivalent to the planar antenna (4a) and comprises the first layer (12a), the second layer (13a) and the third layer (14a). The planar antenna (4a) is shown in the cross section (3) as antenna group (21a), while the antenna group (21a) is shown in the topview (2) as the planar antenna (4a). The other antenna groups (21b and 21c) correspond to the antenna group (21a), respectively. The first, second and third layer (12a, 13a, 14a) have equal distances to each other, but are not restricted to this embodiment. Also in FIG. 1 all three layers (12a, 13a, 14a) have the same size and are aligned along the axis A which is perpendicular to the ground layer 15. In other examples the layers (12a, 13a, 14a) might be shifted to each other, either horizontally or vertically, to vary the reciprocal stimulation by electromagnetic waves. The bottom layer (14a, 14b, 14c) is connected to the microstrip line (6a, 6b, 6c) and stimulates the other above placed layers (12a, 13a, 12b, 13b, 12c, 13c). In another example the other layers might also be connected to the microstrip lines, respectively. Thereby any combination of connected layer to the microstrip line is possible, more specifically said that either the first and the third or the second and the first layer (and so on) might be connected to said microstrip line. Also the planar antennas are not restricted to only 3 layers, but may comprise at least one layer, respectively.

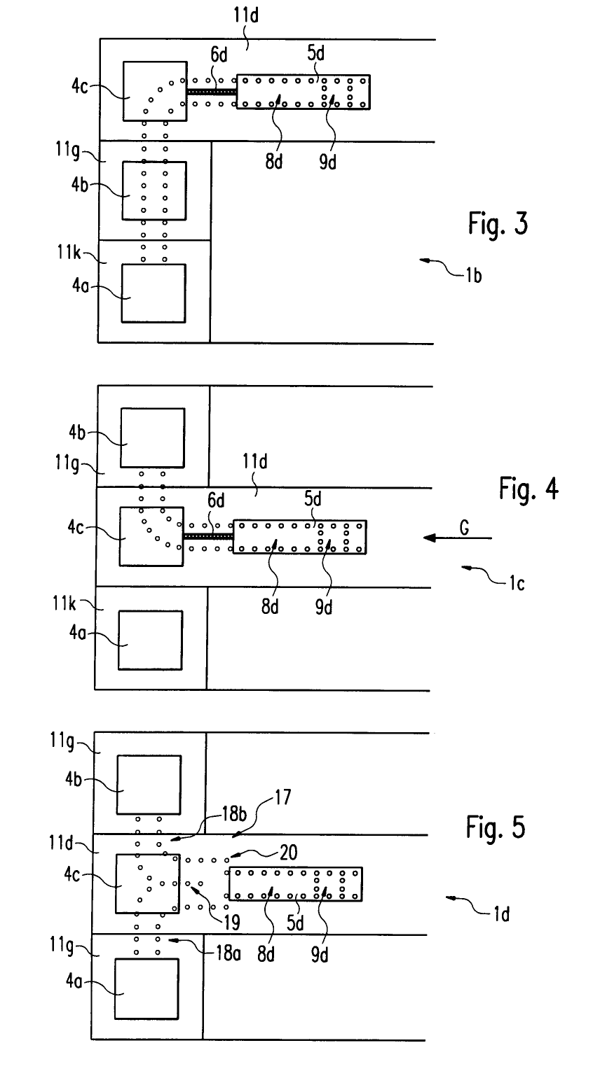

The third substrate integrated waveguide (5c) comprises several vias wherein exemplarily one via of the third filter channel is referenced as 10c. The vias are produced through one layer and connect the upper layer (22a) with the lower layer (22b) of the third substrate integrated waveguide (5c). The vias are all parallel to each other and perpendicular to the ground layer. The upper and the lower layer (22a and 22b) are basically formed like the microstrip lines (e.g. 6c or 7c) but with a larger width than said microstrip lines. All components, except for the layers (11a, 11b, 11c) shown in FIG. 1, are composed of metal like for example gold or copper or multilayer out of gold and copper whereby said vias are either completely filled or lined with said metal composition. The layers (11a, 11b, 11c) are composed of any flexible material like for example liquid crystal polymere. The thickness of the layers can be 25 or 50 or 100 μm, but could be more or less depending on the design frequency. The distances between the vias is in the range of λg/10 whereby λg stands for the wavelength in the substrate. The vias should not be placed so far from each other, so that the energy will not leak between the posts. The diameter of the via depends on the substrate height, thus due to fabrication specifications said diameter is increased when the total substrate height is increased. The diameter of the vias favourably ranges between 100 μm to 200 μm and is not restricted to said values, but is eventually dependent on the frequency. Regarding the fabrication, all parts (antenna, filters and conductors) are fabricated at the same time within the same layer. Vias can either be made after the complete substrate structure is finished or at the same step when the components of the same layer are made. It is of course possible to omit the microstrip lines (6a, 6b, 6c) and directly connect the substrate integrated waveguides to the antennas, if necessary by bending or forming a curve of said substrate integrated waveguides as explained in FIG. 3, 4 or 5.

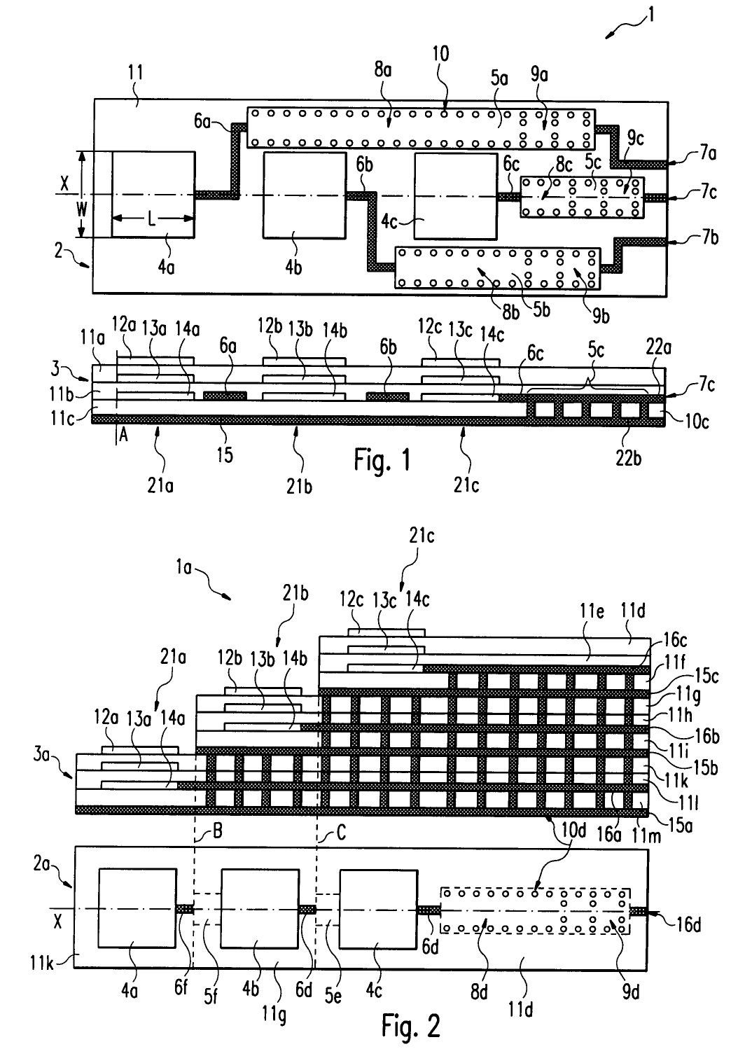

FIG. 2 shows a second example of a substrate structure (1a) comprising a topview (2a) of said second example and a cross section (3a).

The topview (2a) of said second example shows the first, second and third planar antenna (4a, 4b, 4c), a third substrate integrated waveguide (5d), a third microstrip line (6d), a feeding microstrip line (16d), a second and first substrate integrated waveguide (Se, 5f) and a second and first microstrip line (6e, 6f) whereby the first, fourth and seventh layer of the 3D substrate (11k, 11g, 11d) is visible in the topview. Basically all components of the FIG. 2 correspond to the components of FIG. 1, except for or in addition to the succeeding description of the characteristics and features, respectively.

The cross section (3a) of the second example shows nine layers (11d to 11n), six conducting layers (15a, 16a, 16b, 15b, 15c, 16c), vias extending no less than from the ground layer (15a) of the first substrate integrated waveguide until the ground layer (15b) of the second substrate integrated waveguide and eventually vias ranging from the ground layer (15a) of the first substrate integrated waveguide to the toplayer (16c) of the third substrate integrated waveguide and the respective layers (12a, 13a, 14a, 12b, 13b, 14b, 12c, 13c, 14c) of the first, second and third planar antenna. The vias length is not restricted to the above mentioned length but have to range at least from the ground layer to the top layer of the respective substrate integrated waveguide to provide encasement and guidance of electromagnetic waves in said substrate integrated waveguides. The layers of all planar antennas are placed on the first layer to ninth layer of the 3D substrate, respectively, more specifically said every layer of a planar antenna is placed as only layer on said layer of the 3D substrate (11d-11m). The first substrate integrated waveguide (5f) comprises a part of the top layer (16c) and of the ground layer (15c), the second substrate integrated waveguide (5e) comprises a part of the top layer (16b) and of the ground layer (15b) and the third substrate integrated waveguide (5d) comprises a part of the top layer (16a) and of the ground layer (15a). Basically the layers (15a, 15b, 15c, 16a, 16b, 16c) comprise the microstrip lines (6f, 6e, 6d), the substrate integrated waveguides (5f, 5e, 5d) and the feeding microstrip line, like e.g. the one referenced as (16d) visible on the topview (2a), respectively. Said layers (15a, 15b, 15c, 16a, 16b, 16c) have all the same thickness and are parallel to each other, but are not restricted to said technical features. Moreover, there might be interconnections (not shown in FIG. 2) between two neighboring and under each other lying substrate integrated waveguides so that signals can be shared between said SIWGs. The interconnection is formed by a via hole in a bottom layer like e.g. 15b and a top layer of the respective SIWGs like e.g. 16a and by vias forming a channel from the above lying SIWG to the bottom lying SIWG; therefore additional vias have to be placed on the edge around the holes. Other interconnections which allow the splitting or the gathering of signals are also possible. For example a part of the top layer 16a could be gradually led to the bottom layer 15b and merge with said bottom layer. Likewise the bottom layer 15a remaining parallel to the top layer 16a is also gradually led to and merged with said bottom layer 15b. The slope whereon the conducting layer 16a or 15a can be placed on can be manufactured by e.g. grid etching of the respective layers like e.g. 11k to 11m.

FIG. 3 shows a third example of the substrate structure (1b) whereby all components subsequently described are shown in the topview, whereby components below the surface/top layer are partially also shown due to reasons of clarity. Basically all components of the FIG. 3 correspond to the components of FIG. 2, except for or in addition to the succeeding description of the characteristics. The first, second and third planar antenna (4a, 4b, 4c) correspond to the respective planar antennas described in FIG. 2. Accordingly, the three planar antennas are placed on the respective layers (11d, 11g, 11k) as described in FIG. 2. Also the third substrate integrated waveguide (5d) and the third microstrip line (6d) correspond to the respective components described in FIG. 2. The third substrate integrated waveguide (5d) comprises a feeding channel (8d) and a filtering channel (9d). Since the row of the three planar antennas (4a, 4b, 4c) is arranged to the third substrate integrated waveguide (5d) in a 90 degree angel on the layer, the second and the third substrate integrated waveguide form a curve around to connect to the respective planar antenna (4a, 4b). It is also possible that microstrip lines are used to form the curve and respectively interconnect the planar antenna (4a, 4b) with a substrate integrated waveguide (not shown in FIG. 3), said substrate integrated waveguide lying beneath the substrate integrated waveguide (5d). The first layer of the antennas (4a, 4b, 4c) is visible and placed on the respective layer of the 3D structure (11k, 11g, 11d).

FIG. 4 shows a fourth example of the substrate structure (1c) wherein the subsequently described features are shown in the topview, whereby components below the surface/top layer are partially also shown due to reasons of clarity. Basically all components of the FIG. 4 correspond to the components of FIG. 3, except for or in addition to the succeeding description of the characteristics. The first, second and third planar antenna (4a, 4b, 4c), the third substrate integrated waveguide (5c) and the third microstrip line (6d) correspond to the same components described in FIG. 3 respectively. In this case, the third planar antenna (4c) is located inbetween the second and the first planar antenna. Thus, the first and the third planar antenna and the third substrate integrated waveguide form a 90 degree angle as well as the second and third planar antenna and the third substrate integrated waveguide also form a 90 degree angle. Therefore, the first and the second substrate integrated waveguides are also curved-shaped beneath the layers of the third planar antenna (4c) whereby in the view of the arrow G, the second substrate integrated waveguide turns to the right (shown as two rows of circles being lined up and in parallel) and the third substrate integrated waveguide turns to the left to connect to the respective planar antenna. In particular, the second substrate integrated waveguide is on a different layer than the third substrate integrated waveguide. The first layer of the antennas (4a, 4b, 4c) is visible and placed on the respective layer of the 3D structure (11k, 11g, 11d).

FIG. 5 shows a fifth example of the substrate structure (1d), whereby all subsequently described features are shown in the topview, whereby components below the surface/top layer are partially also shown due to reasons of clarity. Basically all components of the FIG. 5 correspond to the components of FIG. 4, except for or in addition to the succeeding description of the characteristics. Except for the diplexer (17), all other components which are shown in FIG. 5 correspond to the components described in FIG. 4. The diplexer (17) is located beneath the layers of the third planar antenna and is allocated after the third substrate integrated waveguide. The diplexer (17) is operable to provide electromagnetic waves to the first planar antenna and the second planar antenna, respectively located on the right or left side of the third planar antenna. The diplexer (17) comprises a first branch (18a) connecting to the first planar antenna (4a) and a second branch (18b) connecting to the second planar antenna (4b). Eventually the feeding channel located below the feeding channel (8d) of the substrate integrated waveguide (5d) is widenend at the end by vias (20), said vias (20) acting as entrance corners of the diplexer (17). The diplexer (17) is finally split into two branches by the separation vias (19) being positioned in the middle of the channel's width. Depending on the distribution of the signal strength the separation vias (19) can be moved to provide more power to a specific planar antenna. The first layer of the first and second antenna (4a, 4b) is visible and is located on the same layer of the 3D structure (11g).

A solution to the rectangular waveguide (WG) of the state of the art is to integrate rectangular WG into a claded substrate as substrate integrated waveguides (SIWG) as shown in the FIGS. 1 to 5. The SIWG techniques are characterized by their low-loss, low-cost and have been reported in many publications for microwave and mm-wave components and subsystems.

The SIWG, antenna feeding, antenna itself and channel filters are manufactured in one component and from the same material and in the same fabrication steps (FIG. 1). There is no need to design complicated transitions between the sub-circuit components since the same manufacturing technique is used for all components. For further system miniaturization, individual components are arranged in a multilayer configuration which is called 3D module (FIG. 2).

Multiple components can be stacked on top of each other to form more complex integrated module (FIG. 2). The advantage of this stacked arrangement is that during manufacturing processing the via-holes needed for the creation of the SIWG can be made in one step. This yields to very low production costs and also to very low differences in performance between the individual components.

The SIWG is fabricated from a flexible board-material so that it can be bent or have any shape in order to minimize the overall system size. This flexible board material comprises e.g. liquid crystal polymer.

Conventional rectangular WGs are bigger in size, bulky and heavy in weight. In contrast, SIWG are much smaller in size and hence need less space for integration in a system. Like a conventional rectangular WG, SIWG does not radiate outside the waveguide and therefore, has low loss and negligible crosstalk.

Since the SIWG is fabricated from a claded (metalized) substrate, the antenna part, the SIWG, and other circuit-components like channel filters can be made by the same production techniques, within the same production steps and so from the same material.

According to FIG. 1, the transition between the SIWG and the antenna will be much simplified, whereby said transition comprises a simple microstrip, coplanar, or via transition. As precision in the micrometer range is needed for mm-wave waveguide applications, the fabrication process using etching techniques (used for SIWG) is dedicated compared to metal milling as needed for conventional waveguides.

SIWGs offer the possibility to have a multilayer architecture. The SIWGs can be integrated in a multilayer configuration and thus, saving much space and the feeding WGs will not suffer from cross-talk. Using flexible material for the SIWG can further minimize the system size by folding and thus, leads to a higher density of integration.

Up to now circuit boards, antennas, feeding networks and subcomponents like channel filters have been made as separate parts and connected together with expensive cable-assemblies. Thus the advantages of the subject-matter of the present invention is as follows:
With SIWG, all these sub-circuit components are integrated into one circuit and so better electrical performance, smaller size, higher density of integration, and finally a cheaper product is achieved.
Smaller in size because components are arranged in a multilayer technique and are manufactured out of the same waveguide-technique (here SIWG).
Better RF-performance due to less cross-talk, fewer transitions between circuit components, less interconnection length (electrical length) and hence, less ripple transmission behaviour.
The same via holes can be used for the different waveguides and especially for waveguide filters on different layers. These simplify the manufacturing process and hence, drop the production costs. In addition, as the via hole process is shared between multiple components the production yield is increased due to less process variation needed to be taken into account.

The liquid crystal polymers (LCP), which are now explained in detail, are only an example of a material which can be used in the present invention. Liquid crystal polymers are a relatively unique class of partially crystalline aromatic polyesters based on p-hydroxybenzoic acid and related monomers. Liquid crystal polymers are capable of forming regions of highly ordered structure while in the liquid phase. Typically LCPs have outstanding mechanical properties at high temperatures, excellent chemical resistance, inherent flame retardancy and good weatherability. Liquid crystal polymers come in a variety of forms from sinterable high temperature to injection moldable compounds. Sintering is a method for making objects from powder, by heating the material (below its melting point) until its particles adhere to each other. LCPs are exceptionally inert. They resist stress cracking in the presence of most chemicals at elevated temperatures, including aromatic or halogenated hydrocarbons, strong acids, bases, ketons, and other aggressive industrial substances. Hydrolytic stability in boiling water is excellent. Environments that deteriorate the polymers are high-temperature steam, concentrated sulfuric acid, and boiling caustic materials.

1. A substrate integrated structure (1) operable to guide electromagnetic waves in, said substrate integrated structure (1) being one integrated unit, comprising
a plurality of substrate integrated waveguides (5a, 5b, 5c) operable to guide an electromagnetic wave, respectively, and
a plurality of planar antennas (4a, 4b, 4c) operable to receive and/or emit electromagnetic waves, said plurality of planar antennas (4a, 4b, 4c) being coupled to said plurality of substrate integrated waveguides (5a, 5b, 5c), respectively.

2. A device according to claim 1,
wherein said substrate integrated waveguides (5a, 5b, 5c) comprise vias (10c) and microstrip conductors (22a & 22b).

3. A device according to claim 1 or 2,
wherein at least one of said substrate integrated waveguides (5a, 5b, 5c) comprises an electromagnetic wave frequency filter (9a, 9b, 9c).

4. A device according to one of the above mentioned claims,
wherein at least one of said substrate integrated waveguides (5a, 5b, 5c) comprises an interconnection, said interconnection being operable to interconnect at least two of said substrate integrated waveguides (5a, 5b, 5c).

5. A device according to claim 4,
wherein said interconnection comprises a multiplexer (17).

6. A device according to one of the above mentioned claims,
wherein said substrate integrated structures (1) are implemented in a multilayer substrate (11).

7. A device according to one of the above mentioned claims,
wherein at least two of said planar antennas (4a, 4b, 4c) are located at different layers, respectively.

8. A device according to one of the above mentioned claims,
wherein at least two of said substrate integrated waveguides (5a, 5b, 5c) are located at different layers, respectively.

9. A device according to claim 8,
wherein at least a part of said vias (10c) are a part of all substrate integrated waveguides (5a, 5b, 5c) concurrently.

10. A device according to one of the above mentioned claims,
wherein the connection between at least one of said planar antennas (4a, 4b, 4c) and said respective substrate integrated waveguide (5a, 5b, 5c) comprises a microstrip line (6a, 6b, 6c).

11. A device according to one of the above mentioned claims,
wherein the substrate integrated waveguides (5a, 5b, 5c) are parallel to each other.

12. A device according to one of the above mentioned claims,
wherein the planar antennas (4a, 4b, 4c) are parallel to each other.

13. A device according to one of the above mentioned claims,
wherein at least one substrate integrated waveguide is located on one side of the planar antennas (4a, 4b, 4c) and at least one substrate integrated waveguide is located on the other side of the planar antennas (4a, 4b, 4c).

14. A method for manufacturing a device corresponding to one of the claims 1 to 13, said device comprising a plurality of layers, said layers comprising components, respectively,
wherein vias are produced through a layer of said device in the same step as a component of the respective layer and/or the respective layer are/is produced.

15. A method for producing a device, said device corresponding according to one of the above mentioned claims 1 to 13 and said device comprising a plurality of layers, said layers comprising components, respectively,
wherein vias are produced through said device after all other components of the device are produced.

16. A method for producing a device according to claim 15,
wherein vias extend perpendicular through at least one layer.
